(19) United States
(12) Patent Application Publication
(10) Pub. No.: US 2012/0205083 A1
(43) Pub. Date: Aug. 16, 2012

(54) FLOOR FOR A HEAT EXCHANGER, PRODUCTION METHOD, AND DEVICE FOR THE PRODUCTION

(76) Inventors: Jörg Bergmiller, Ostfildern (DE); Mathias Wendorf, Weissach (DE); Volker Velte, Otisheim (DE)

(21) Appl. No.: 13/391,372

(22) PCT Filed: Aug. 6, 2010
(86) PCT No.: PCT/EP2010/061526

§ 371 Date: May 2, 2012

(30) Foreign Application Priority Data
Aug. 21, 2009 (DE) 10 2009 038 299.2

(51) Int. Cl. B21D 51/38; B21D 53/02; B21D 19/08; B21D 28/26; F28F 9/02; B23P 15/26

(52) U.S. Cl. 165/173; 29/890.052; 29/727; 72/370.11

(57) ABSTRACT

A method and apparatus for producing a floor for a heat exchanger may include supplying a material strand to a tool and at least partially introducing a passage of the floor into the material strand by at least one stamp of the tool. The material strand may be advanced by a predetermined distance in a longitudinal direction. The introducing and advancing may be repeated until a predetermined number of passages has been introduced into the floor.

### CROSS-REFERENCE TO RELATED APPLICATIONS

This application claims priority to German Patent Application 10 2009 038 299.2 filed on Aug. 21, 2009 and PCT/EP2010/061526 filed on Aug. 6, 2010, which are hereby incorporated by reference in their entireties.

### TECHNICAL FIELD

The invention relates to a method for producing a floor for a heat exchanger according to claim 1, a heat exchanger produced according to this method, and a device for producing a floor for a heat exchanger according to claim 14.

### BACKGROUND

Producing a floor of the heat exchanger from an aluminum plate, in that all of the passages of the floor are stamped out simultaneously using a tool manufactured individually for the production of the floor, is known from practice in the construction of heat exchangers for motor vehicles, for example, refrigerant coolers or charge air coolers. The shape of the individual passages, their spacing, and their number for a given toolkit are fixedly predefined by the tool.

It is the object of the invention to specify a method for producing a floor for a heat exchanger, by means of which small and moderately-sized series of floors are also producible cost-effectively.

This object is achieved according to the invention by a method having the features of claim 1. Through the repeated introduction of a passage into the material strand and the following advance, a floor of arbitrary pre-settable length or having an arbitrary number of passages in the longitudinal direction can be produced, without the tool having to be changed. Only one passage or an integral fraction of the passages of the floor are introduced with each advance step. Cutting off the floor after reaching the desired number of passages is expediently performed in the same device. For example, the material strand can consist of rod material or roll material and is generally provided as a quasi-endless material strand, from which a plurality of floors are formed one after another. The present invention relates in particular to floors of heat exchangers in aluminum construction, but may fundamentally also be transferred to other materials such as steel.

### SUMMARY

In a preferred embodiment of the invention, the introduction of the passage according to step b. occurs in multiple steps, multiple stamps of the tool being arranged one behind another in the longitudinal direction. The passage can be shaped and stamped out in the material strand step-by-step in this way. A calibration step can optionally also be performed after the stamping out or the production of the opening, in order to process the edges of the passage particularly precisely.

In a further preferred embodiment, reshaping of the edge section of the material strand extending in the longitudinal direction by means of at least one stamp of the tool is additionally provided. The reshaping can consist of raising the edge, for example. It can be performed by means of one or also a plurality of the stamps, which are implemented to shape the passage, or also by means of a stamp separately provided for reshaping the edge. In particular, the reshaping of the edge can be performed in multiple steps.

Alternatively or additionally to the reshaping of the edge by a stamp, reshaping of the edge section extending in the longitudinal direction can also be performed by means of a roller tool or reshaping tool. The roller tool can comprise one or more steps or roller stations.

In a further embodiment, it can additionally be provided that a stiffening structure is introduced between adjacent passages by means of a stamp of the tool. Such a stiffening structure can be a reinforcement bead or other formation, for example.

In general, a method according to the invention advantageously also comprises the step that step b. is omitted after an advance according to step c., in order to form an area which is not provided with a passage between two floors arranged one after another in the longitudinal direction in the material strand. This can particularly be an area for separating the sequential floors, so that a sufficiently large spacing remains between the last passage and the frontal edge of the floor. Multiple omissions are also possible in particular, if this spacing is to be correspondingly large.

In a further embodiment of the invention, the material strand is implemented as a reshaped profile, in particular having raised edges. In a preferred detail design, the material strand can be implemented as a braze-clad and pre-shaped sheet-metal strip or as an extruded profile.

In addition, the invention comprises a floor of a heat exchanger produced according to a method according to the invention. The floor can be implemented having one row or multiple rows depending on the requirements. In a multirow implementation, the passages are advantageously arranged aligned one behind another in their longitudinal direction. However, offset or other arrangements can also be provided.

In addition, the invention relates to a heat exchanger having a floor according to the invention. The heat exchanger is particularly preferably a refrigerant cooler, a charge air cooler, an oil cooler, or a fuel cooler for an internal combustion engine. In general, it is preferably a heat exchanger in aluminum construction, in which a stack of flat pipes, which are each folded from aluminum plate or are implemented as an extruded profile, for example, are fixed in the passages of the floor and soldered until materially bonded. The soldering of the heat exchanger is advantageously performed, after mechanical preinstallation or coffering of at least the flat pipes and the floor, in a soldering furnace.

A metal collector box, made of cast aluminum in a preferred detail design, is generally advantageously fixed on the floor of the heat exchanger according to the invention. The implementation from cast aluminum allows simple adaptation to simply shaped floors, which do not have raised edges on their front side in particular. The collector box can be fixed on the floor by means of welding in particular. Alternatively, however, a collector box fixed by means of soldering, in particular joint soldering in a soldering furnace, is also conceivable, or also a collector box made of plastic. In the case of a collector box which is not cast, but rather shaped from sheet metal, for example, frontal terminus plates can be provided for attachment to the open front side of the floor.

The object of the invention is additionally achieved for a device for producing a floor for a heat exchanger having the features of claim 14. In a preferred detail design, the production of the floor is performed according to a method according to the invention according to one of claims 1 to 8. Through the successive introduction of passages by means of the multistep stamping in conjunction with an advancing device, the production device can be designed as particularly simple and cost-effective overall. In particular the shaping and dimensioning of the stamps for the multistep stamping allows low costs, since only precisely one stamp having a passage form is required per shaping step; alternatively, multiple stamps can also be used.

In a particularly preferred refinement, the stamps of the device according to the invention are fixable in the receptacle at a selectable settable spacing to one another.

In this way, a variation of the spacing of the passages may be made possible using the same stamps. Therefore, a change of the tool is not necessary to produce a differently shaped floor, but rather only the selection of a different setting of the tool.

Further advantages and features of the invention result from the exemplary embodiments described hereafter and from the dependent claims.

### BRIEF DESCRIPTION OF THE DRAWINGS

Multiple exemplary embodiments of the invention are described hereafter and explained in greater detail on the basis of the appended drawings.

FIG. 1 shows a schematic three-dimensional view of a first exemplary embodiment of the invention.

FIG. 2 shows a three-dimensional view of a second exemplary embodiment of the invention.

FIG. 3 shows a three-dimensional view of a third exemplary embodiment of the invention.

FIG. 4 shows a three-dimensional view of a collector box for a floor according to FIG. 1 to FIG. 3.

### DETAILED DESCRIPTION

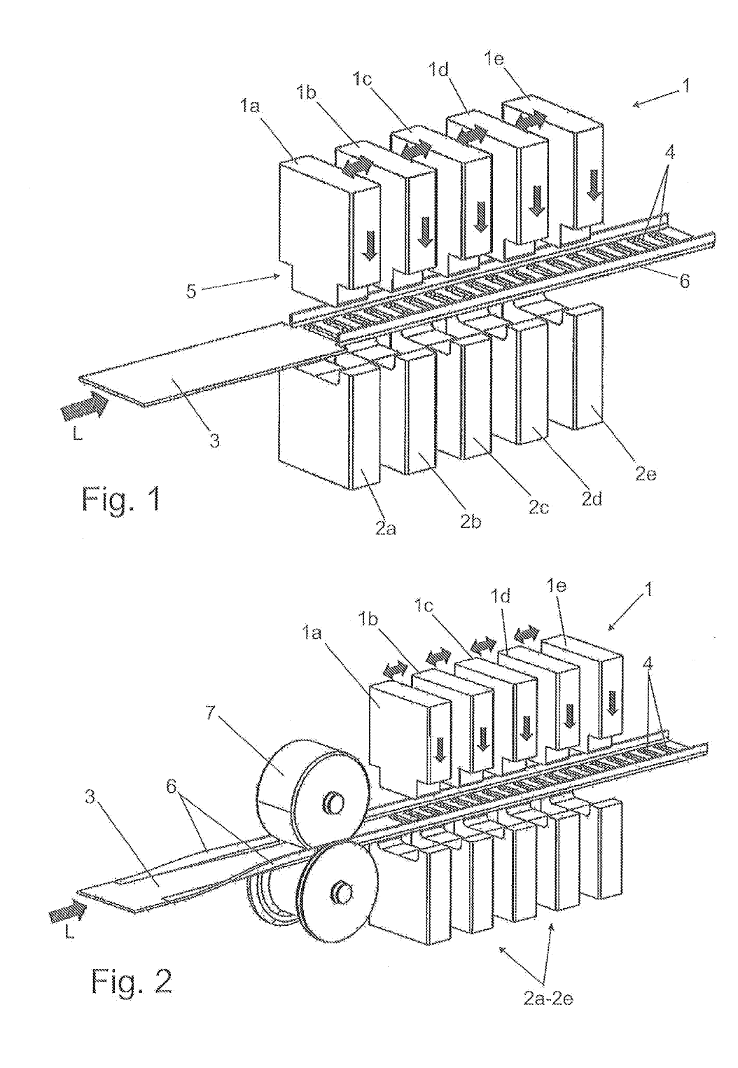

The device according to the invention shown in FIG. 1 for the production of a floor for a heat exchanger comprises five stamps 1a, 1b, 1c, 1d, 1e arranged one behind another, which are fixed as a whole in a receptacle (not shown) and form a tool 1. The tool 1 additionally comprises cushions 2a-2e opposite to the stamps 1a-1e.

An advancing device (not shown) guides a material strand 3 in a longitudinal direction L between the stamps 1a-1e and the cushions 2a-2e, a step-by-step advance of the material strand 3 being performed. The advancing device can be implemented as a roller transport device or in another way.

Each of the stamps 1a-1e has a formation 5 for the step-by-step introduction of passages 4 into the material strand 3, the passages 4 being implemented as oblong openings having well-defined edges for accommodating flat pipes.

Each of the stamps 1a-1e represents one step of a multistep stamping procedure for a respective passage 4. According to the vertical arrows, the respective stamp 1a-1e is lowered together with the receptacle or all of the further stamps downward onto the material strand 3, the respective passage 4 initially being slightly shaped, then shaped further, and finally stamped out for the complete opening in the course of passing through the individual stamps 1a-1e. Depending on the requirements, one or more calibration steps can still be provided after the occurrence of the opening, by means of which precise shaping of the edges of the passages is ensured.

Furthermore, the stamps 1a-1e and the cushions 2a-2e comprise corresponding graduations 5, by means of which an edge 6 of the material strand extending in the longitudinal direction is reshaped, in the present case by step-by-step bending upward into the finally vertical raising of the edge 6. The drawing of FIG. 1 is only schematic with respect to the individual reshaping steps of the passages 4 and the edges 6. In particular, the figure shows a complete reshaping of edges 6 and passages 4 already under the first of the stamps 1a. It is to be understood that the schematically shown reshaping of the material strand 3 occurs successively over the five steps 1a-1e.

Overall, through the introduction of the passages 4 and the bending upward of the edges 6, a floor is shaped from the material strand 3, which is cut off from the material strand 3 after a defined number of passages 4. Therefore, an arbitrary number of floors can be implemented from an endless material strand through step-by-step advancing, in particular by one passage spacing in each case, the number of the passages per floor being made variable through simple control of the advance or selection of the location of the cutting through.

The arrows shown between the individual stamps 1a-1e indicate a resolvable adjustability of the stamps 1a-1e and the cushions 2a-2e to one another. The spacing of adjacent passages from one another can also be set according to requirements in this way. Through the device according to the invention, both a number of the passages per floor and also the spacing of the passages per floor are variable without changing the tool.

In the embodiment according to FIG. 2, a roller set 7 is additionally arranged upstream from the set of stamps 1a-1e, by means of which the edges 6 of the material strand 3 are bent upward. The graduations 5 of the stamps 1a-1e which are also included in FIG. 2 are therefore not necessary for reshaping edges 6. However, reshaping can also be performed by a combination of roller tool 7 and graduations 5 of the stamps 1a-1e. The roller set can also comprise multiple rollers one behind another for the step-by-step reshaping of the edge 6.

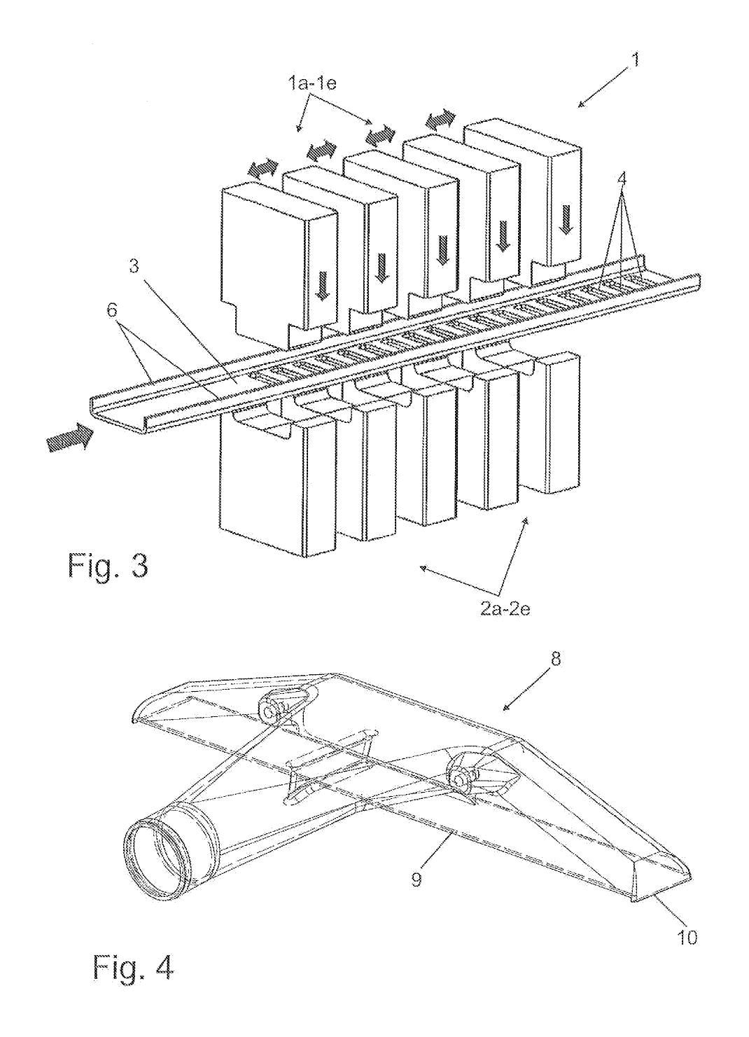

In the exemplary embodiment shown in FIG. 3, the supplied material strand 3 already has raised edges 6. In this example, the material strand 3 can be implemented particularly advantageously as an extruded profile part. However, a material strand 3 can fundamentally also be implemented in each of the examples as sheet-metal strips, in particular braze-clad sheet-metal strips from a sheet-metal roll, for example.

FIG. 4 shows a three-dimensional view of a collector box 8, which is implemented as a cast part made of aluminum. The collector box 8 is completed using a quasi-endless floor according to the invention to form a collector of the heat exchanger according to the invention, in that it is welded to the floor along edges 9 of its longitudinal sides and edges 10 of its narrow sides. The edges 9 of the collector 8 press against the raised edges 6 of the floor, whereby the welding is made easier with respect to the dimensional tolerances. The edges 10 of the short narrow sides of the collector box 8 are drawn down lower and correspond to the open front sides of a floor according to the invention. It is also conceivable to further reshape the floor according to the invention on its front sides before or after it is cut off of the material strand 3.

The direction of the raising of the edges 6 is arbitrary in all of the exemplary embodiments depending on the requirements, i.e., either toward the side of the flat pipes or toward the other side.

It is obvious that the individual features of the above-described exemplary embodiments are combinable with one another in reasonable ways depending on the requirements.

1. A method for producing a floor for a heat exchanger, comprising:
supplying a material strand to a tool;
at least partially introducing a passage of the floor into the material strand by at least one stamp of the tool;
advancing the material strand by a predetermined distance in a longitudinal direction;
repeating the introducing and advancing until a predetermined number of passages has been introduced into the floor.

2. The method according to claim 1,
wherein multiple stamps of the tool are arranged one behind another in the longitudinal direction.

3. The method according to claim 1, including:
reshaping an edge section of the material strand, which extends in the longitudinal direction, by the at least one stamp of the tool.

4. The method according to claim 1, including:
reshaping an edge section of the material strand, which extends in the longitudinal direction, by a roller tool.

5. The method according to claim 1, including:
introducing a stiffening structure between the passages by the at least one stamp of the tool.

6. The method according to claim 1, including:
after the advancing of the material strand, forming an area, which is not provided with a passage, between two floors arranged one behind another in the longitudinal direction in the material strand.

7. The method according to claim 1,
wherein the material strand is implemented as a pre-shaped profile.

8. The method according to claim 7, wherein the material strand is implemented as at least one of a sheet-metal strip and an extruded profile part.

9. (canceled)

10. The method according to claim 1, wherein the floor is implemented as having at least one row.

11. The method according to claim 1, wherein the heat exchanger is at least one of a refrigerant cooler and a charge air cooler for an internal combustion engine.

12. The method according to claim 1, including fixing a metal collector box on the floor.

13. The method according to claim 12, wherein the collector box is welded on the floor.

14. A device for producing a floor for a heat exchanger, comprising:
a stamping tool having a receptacle movable in a stamping direction,
a plurality of stamps each being fixed in the receptacle in a longitudinal direction, and formed for a multistep stamping of a passage of the floor, and
an advancing device for advancing a material strand in the longitudinal direction.

15. The device according to claim 14, wherein
the stamps are fixable in the receptacle having a selectable settable spacing to one another.

16. The device according to claim 14, wherein the floor is implemented as having at least one row.

17. The device according to claim 14, wherein the heat exchanger is at least one of a refrigerant cooler and a charge air cooler for an internal combustion engine.

18. The device according to claim 14, including a metal collector box fixed on the floor.

19. The device according to claim 18, wherein the collector box is welded on the floor.

20. The method according to claim 1, wherein the material strand has raised edges.

21. A method for producing a floor for a heat exchanger, comprising:
supplying a material strand to a tool;
advancing the material strand by a predetermined distance in a longitudinal direction; and
forming an area between two floors arranged one behind another in the longitudinal direction in the material strand.
